(19) United States
(12) Patent Application Publication
(10) Pub. No.: US 2026/0091980 A1
(43) Pub. Date: Apr. 2, 2026

(54) SYSTEM FOR FORMING ACTIVATED OR DEVOLATILIZED CARBON FROM COAL OR BIOMASS BY PRESSURIZED PYROLYSIS AND METHODS OF USE

(71) Applicant: CHRISTOPHER L ABEYTA, Farmington, NM (US)

(72) Inventor: CHRISTOPHER L ABEYTA, Farmington, NM (US)

(21) Appl. No.: 18/900,879

(22) Filed: Sep. 29, 2024

(51) Int. Cl. C01B 32/39; B01J 20/20; B01J 20/30; C01B 32/318; C02F 1/28; C02F 101/36; C05G 1/00; C05G 5/40; C10L 5/08

(52) U.S. Cl. CPC C01B 32/39; B01J 20/20; B01J 20/3078; C01B 32/318; C02F 1/283; C05G 1/00; C05G 5/40; C10L 5/08; C02F 2101/36; C10L 2200/0469

(57) ABSTRACT

The subject of this disclosure may relate generally to forming activated or devolatilized carbon by pressurized pyrolysis from coal or biomass and its methods of use for capturing PFAS in aqueous environments and its methods of use for forming soil fertilizers.

### FIELD OF INVENTION

The subject of this disclosure may relate generally to systems and devices for forming activated or devolatilized carbon from coal or biomass by pressurized pyrolysis and methods of use.

### BACKGROUND OF THE INVENTION

There is a growing concern, now international in scope, over the effects of global warming, caused significantly by industrial emissions of greenhouse gases (primarily Carbon dioxide [CO2], Methane [Ch4], etc.) into earth's troposphere.

Though natural forces can contribute to global warming, it has been estimated that the influence of industrial activities that emit greenhouse gases (significantly, processes that burn fossil fuels) have, since the onset of the industrial revolution (1760), contributed to a vast increase in the extent and pace of global warming. Such warming now poses the following deleterious impacts on weather patterns and events (climate change) and ecosystems: (1) expansion of deserts, replacing agriculturally fertile areas; (2) increased occurrence of heat waves, with consequent increases in wildfires; (3) in the Arctic, melting of permafrost, loss of sea ice, and glacial retreat—contributing to loss of wildlife habitat and increase in ocean temperatures, levels, and acidity; (4) increased frequency of intense, destructive storms (e.g., hurricanes, tornadoes, heavy rainfall, heavy snowfall); and (5) relocation or extinction of wildlife species.

There is also a growing concern, now international in scope, over the contamination of Per-and polyfluoroalkyl substances (PFAS), also known as “forever chemicals” in water. Due to their multiple carbon-fluorine (C—F) bonds and tail lengths, PFAS exhibit enhanced chemical and thermal stability, rendering them persistent in the environment and for removal in water.

Because of their widespread use and their persistence in the environment, many PFAS are found in the blood of people and animals all over the world and are present at low levels in a variety of food products and in the environment.

PFAS functional groups include carboxylates, sulfonates, sulfates, phosphates, amines, and others. These functional groups, including dissociated and undissociated forms, govern many fate and transport properties. The ionic state of PFAS's determines its electrical charge and its physical and chemical properties, which in turn control its fate and transport in the environment.

The physicochemical interactions of PFAS chemicals includes: fluorophilic interactions, hydrophobic interactions, electrostatic interactions, interfacial behaviors, cation bridging, ionic exchange and hydrogen bonding.

One of the most important parameters in PFAS is their critical micelle concentration (CMC), which not only affects their transport in the natural environment, but such parameter can also be utilized for PFAS removal from aqueous media.

Based on the many types of current and future PFAS in the environment, the immediate time release of ions, peroxides, hydroxides or carbonates along with mixing different types of activated carbon or ion exchange resins creates an environment to accumulate PFAS's by CMC, the result is enhanced sorbent kinetics resulting in enhanced PFAS capture and removal from the environment.

There is also a growing concern, now international in scope, over magnesium deficiency, also known as hypomagnesemia. Magnesium is essential for more than 300 different enzymatic processes in the body. It has a role in countless body functions such as heartbeat, muscle movement, or the production of hormones. Magnesium is vital for human health, and yet it's estimated that up to 80% of Americans are deficient in this important nutrient.

Magnesium deficiency in soils is a growing concern worldwide, particularly in intensive agricultural systems. This issue is exacerbated by the regulation of fertilizers that primarily focus on nitrogen (N), phosphorus (P), and potassium (K), and neglecting magnesium (Mg) supplementation. Magnesium is crucial for plant growth as it plays a key role in photosynthesis, enzyme activation, and the synthesis of nucleic acids. When soils are deficient in magnesium, plants can suffer from reduced growth and lower yields.

Magnesium is the metal ion found at the center of every chlorophyll molecule, magnesium is the essential element for photosynthesis. With the increasing use of greenhouses and growing lights for the production of agriculture products, the important of adding magnesium as a fertilizer nutrient is essential.

It is in the above-explained context that this patent application is being submitted to the Patent Office, to offer a solution to form activated or devolatilized carbon by pressurized pyrolysis and its methods of use for capturing PFAS and its methods of use for forming soil conditioners or soil fertilizers.

### SUMMARY OF THE INVENTION

The disclosure describes forming activated or devolatilized carbon by pressurized pyrolysis of coal or biomass and modifying the devolatilized biomass carbon to capture PFAS in aqueous environments and for forming time released soil fertilizer.

In an example embodiment, a system comprises: a pressurized pyrolysis reactor chamber for forming activated or devolatilized carbon from coal or biomass. The devolatilized carbon by pressurized pyrolysis sourced from biomass is not a sorbent material, the infusion or the embedding of elements or compounds are achieved by the porosity structure formed by pressurized pyrolysis, especially with CO2 pressurized pyrolysis. The surface area testing was found to be less than 2 m²/g according to the BET method and that resulted from the iodine adsorption number IN.

In various embodiments, the system can further comprise: pressurizing the reactor chamber with inert gasses such as (i.e. carbon dioxide, nitrogen, argon etc.).

In various embodiments, the system can further comprise: capturing all the gasses, oils and tars extracted from the pressurized pyrolysis reaction chamber.

In various embodiments, the system can further comprise: burning hydrogen, acetylene, propane, methane or any suitable gas to produce the heat for the thermal input to the pressurized pyrolysis reaction chamber.

In various embodiments, the system can further comprise: utilizing focusing lenses to concentrate the suns energy for the thermal input to the pressurized pyrolysis reaction chamber.

In an example embodiment, a method of the system comprises: modifying the devolatized biomass carbon to infuse or embed elements or compounds (e.g., magnesium, calcium, sodium, potassium, zinc, strontium, barium etc.) or a combination of to time release an ion, salt, oxide, peroxide, hydroxide, or carbonate to change the ionic state or the electrical charge of PFAS's for capture, which in turn controls its fate and transport in the environment.

In various embodiments, the method can further comprise: mixing the infused or embedded devolatilized biomass carbon with a carbonaceous sorbent material such as activated carbon, reactivated carbon, carbon black or ion exchange resins to time release an ion, salt, oxide, peroxide, hydroxide, or carbonate to enhance the sorbent kinetics for capturing PFAS by adsorption.

In another example embodiment, a method of the system comprises: modifying the devolatized biomass carbon to infuse or embed elements or compounds (e.g., ammonium nitrate, magnesium nitrate, calcium nitrate, potassium nitrate, magnesium, potassium, calcium, urea, phosphate, sulphur etc.) to form a soil fertilizer with the ability to also time release the nutrients that are beneficial to add to soil to increase its fertility.

In various embodiments, the method can further comprise: capturing all the gasses, oils and fertilizer nutrients from the reactor chamber from agricultural products after harvest to capture any fertilizer nutrients for recycling and reuse.

In another example embodiment, a method of the system comprises: combining the devolatized carbon with raw wood by extrusion to form high thermal heating pellets with a reduced carbon emission and carbon footprint.

In another example embodiment, a method of the system comprises: burning the devolatized carbon with hydrogen to provide a high btu low emission fuel.

### BRIEF DESCRIPTION OF THE DRAWINGS

These and other features, aspects, benefits and advantages of the embodiments described herein will become better understood with reference to the following description, claims and accompanying drawings where:

FIG. 1 illustrates a pressurized pyrolysis system configured to form activated or devolatized carbon from coal or biomass, in accordance with various embodiments;

FIG. 2 illustrates a pressurized reactor chamber configured to modifying the devolatized carbon to infuse or embed elements or compounds or in combination to time release an ion, salt, oxide, peroxide, hydroxide, or carbonate to change the ionic state or the electrical charge of PFAS for capture, in accordance with various embodiments;

FIG. 3 illustrates a pressurized reactor chamber configured to modifying the devolatized carbon to infuse or embed elements or compounds to provide nutrients that may be beneficial to add to soil or land to increase its fertility, in accordance with various embodiments;

FIG. 4 is a graphical representation of a CPD model curve for predicted fractional composition (devolatilized) of a coal particle under 20 C/min heating rate

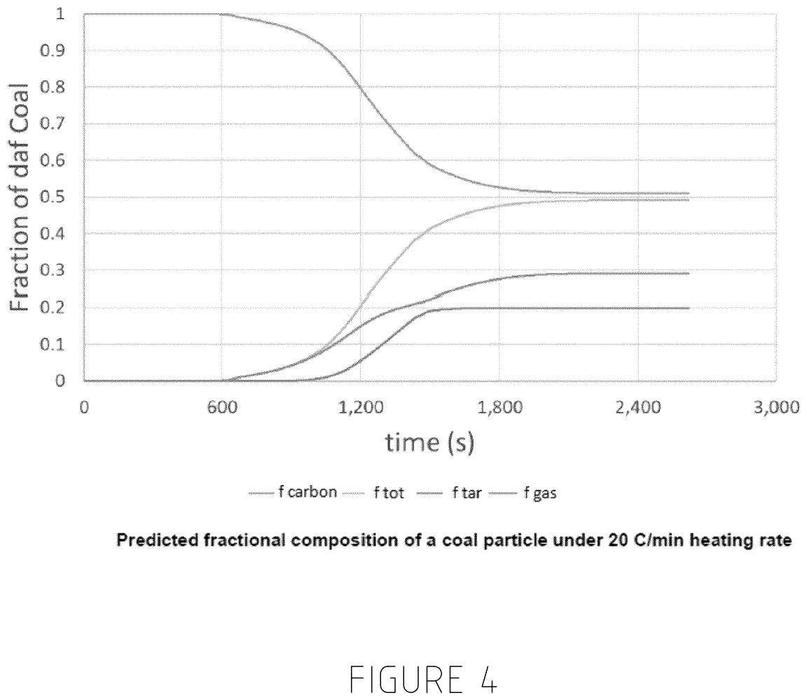

FIG. 5 is a graphical representation of TGA curve versus time with CO2 and 20 C/s

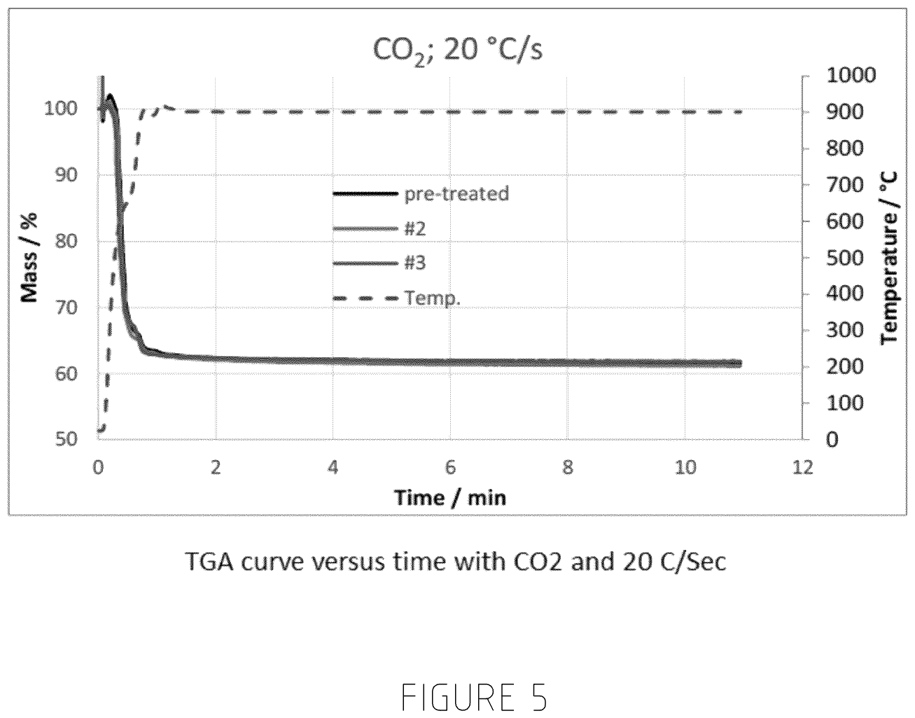

FIG. 6 illustrates an inline PFAS filter for a drinking water bottle application, in accordance with various embodiments;

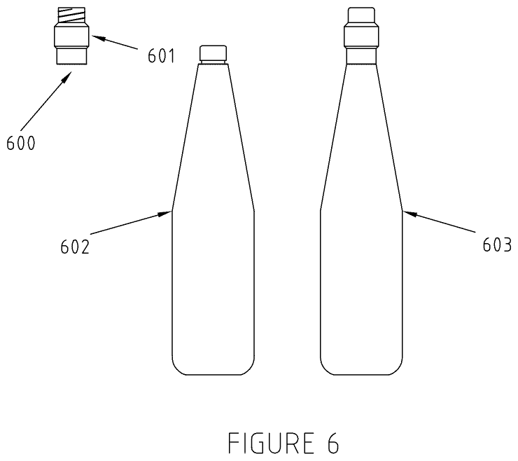

FIG. 7 illustrates an inline PFAS filter for a drinking water canteen application, in accordance with various embodiments;

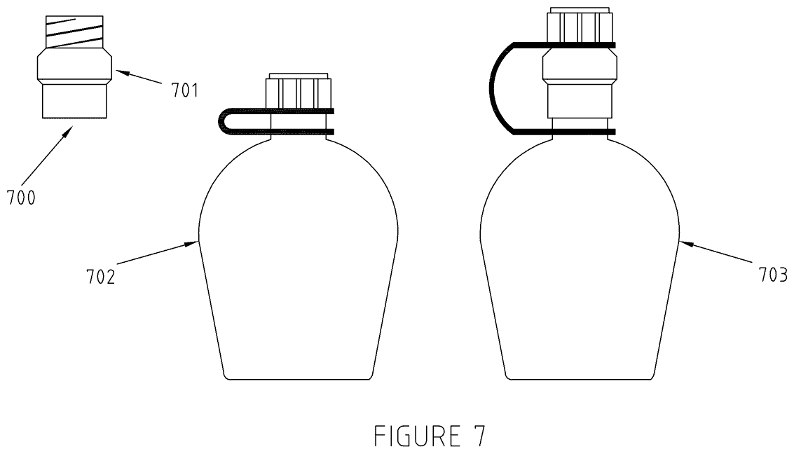

FIG. 8 illustrates an inline PFAS filter for a drinking water dispenser application, in accordance with various embodiments;

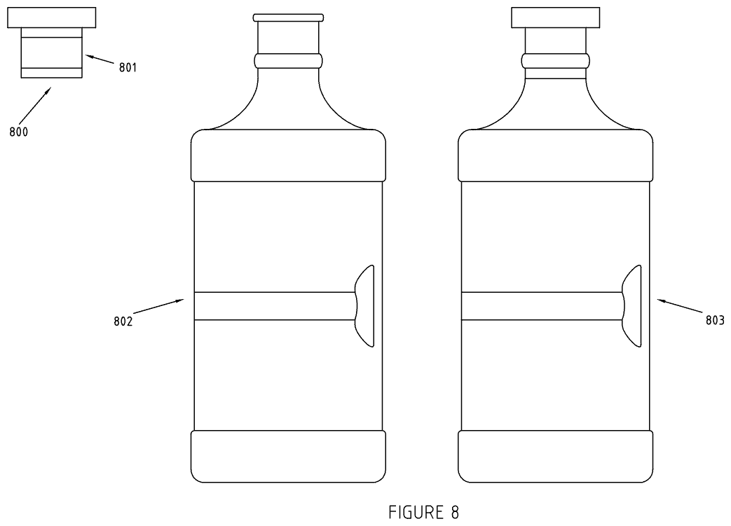

FIG. 9 illustrates a PFAS filter for a drinking water gravity pitcher application, in accordance with various embodiments;

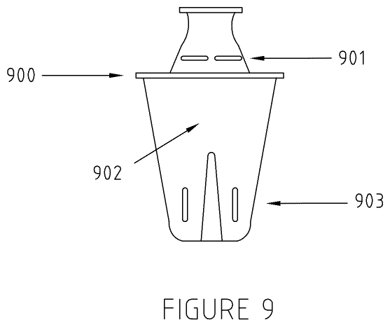

### DETAILED DESCRIPTION

In accordance with the exemplary embodiments of the present invention, systems, methods and devices are not intended as a limitation on the use or applicability of the invention, but instead, are provided merely to enable a full and complete description of the exemplary embodiments.

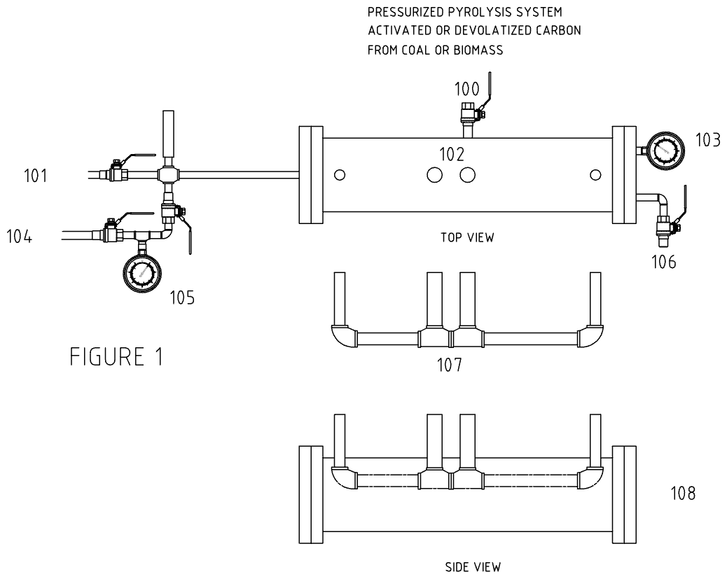

In accordance with an exemplary embodiment, a pressurized pyrolysis reactor chamber is disclosed herein to form activated or devolatized carbon from coal or biomass. Referencing FIG. 1, (108) represents a side view of the manifold (107) positioned in the reaction chamber. The reaction chamber is configured to be rotated to mix the coal or biomass internal in the chamber. The heat input into the reaction chamber is entered through (102). The introduction of steam for carbon activation is introduced thru (100). Pressure and temperature are locally monitored by devices (103, 105). The pressurized inert gas for pyrolysis is introduced by (104). The reactor chamber produced gasses and steam are controlled and released thru (101), the gases can then be captured if required. The reactor chamber produced gasses, liquids, oils and tars are controlled and released thru (106), the gases and volatiles can then be captured if required.

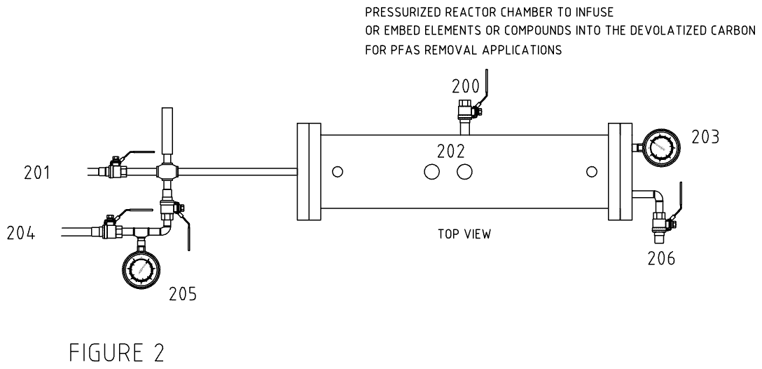

In accordance with an exemplary embodiment, a pressurized reactor chamber is disclosed herein to modify the formed devolatized carbon by infusing or embedding elements or compounds or in combination to time release an ion, salt, oxide, peroxide, hydroxide, or carbonate to change the ionic state or the electrical charge of the PFAS for enhanced capture. With reference to FIG. 2, the heat input into the reaction chamber is entered through (202). The introduction of steam, chemical or metal vapor is introduced thru (200) if required. Pressure and temperature are locally monitored by devices (203, 205). The pressurized gas or oxygen utilized for infusing or embedding into the devolatized biomass carbon is introduced thru (204). The reactor chamber produced gasses are controlled and released thru (201), the gases can then be captured if required. The reactor chamber produced gasses, liquids, oils and tars are controlled and released thru (206), the gases and volatiles can then be captured if required.

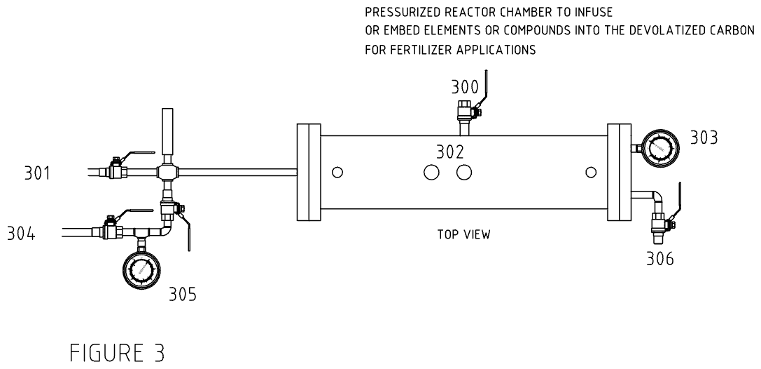

In accordance with an exemplary embodiment, a pressurized reactor chamber is disclosed herein to modify the formed devolatized carbon to infuse or embed elements or compounds or in combination that may be beneficial to add to soil to increase its fertility. With reference to FIG. 3, the heat input into the reaction chamber is entered through (302). The introduction of steam, NH3 or vaporized urea if required is introduced thru (300). Pressure and temperature are locally monitored by devices (303, 305). The pressurized gas or oxygen utilized for infusing or embedding into the devolatized biomass carbon is introduced by thru (304). The reactor chamber produced gasses are controlled and released thru (301), the gases can then be captured if required. The reactor chamber produced gasses, liquids, oils and tars are controlled and released thru (306), the gases and volatiles can then be captured if required.

It should be appreciated that the particular implementations shown and described herein are illustrative of various embodiments including its best mode and are not intended to limit the scope of the present disclosure in any way or are intended to represent all exemplary functional relationships possible.

While the principles of the disclosure have been shown in embodiments, many modifications of structure, arrangements, proportions, devices, materials and components, used in practice, which are particularly adapted for a specific environment and operating requirements without departing from the principles and scope of this disclosure. These and other changes or modifications are intended to be included within the scope of the present disclosure and may be expressed in the following claims.

I claim:

1. A system comprising:
A pressurized pyrolysis reactor chamber for forming activated or devolatized carbon from coal or biomass.

2. The system of claim 1, may comprise pressurizing the reactor chamber with an inert gas such as carbon dioxide, nitrogen or argon.

3. The system of claim 1, may comprise capturing all gasses, oils and tar extracted from the pyrolysis reactor chamber to eliminate or reduce the emissions into the atmosphere.

4. The system of claim 1, may comprise burning hydrogen, acetylene, propane, methane or any suitable gas to produce the required thermal input to the pressurized pyrolysis reactor chamber.

5. The system of claim 1, may comprise focusing lenses to concentrate the suns energy to produce the required thermal input to the pressurized pyrolysis reactor chamber.

6. A method of claim 1, may comprise combining the devolatized carbon with raw wood by extrusion to form high btu heating pellets for reduced carbon emissions.

7. The method of claim 1, may comprise burning the devolatized carbon with hydrogen to provide a high btu low emission fuel.

8. A method of the system comprising:
Modifying the formed devolatized biomass carbon in the pressurized reactor chamber to infuse or embed elements or compounds for PFAS capture.

9. The method of claim 8, may comprise utilizing magnesium, calcium, sodium, potassium, zinc, strontium, barium or a combination to time release an ion, salt, oxide, peroxide, hydroxide, or carbonate to change the ionic state or the electrical charge of the target PFAS for capture and removal.

10. The method of claim 8, may comprise mixing the infused or embedded devolatilized biomass carbon with a carbonaceous sorbent material such as activated carbon, reactivated carbon, carbon black, graphite carbon or ion exchange resins to enhance the sorbent kinetics for capturing PFAS by adsorption.

11. A method of the system comprising:
Modifying the formed devolatized biomass carbon in the pressurized reactor chamber to infuse or embed elements or compounds for forming soil fertilizer.

12. The method of claim 11, may comprise utilizing ammonium nitrate, magnesium nitrate, calcium nitrate, potassium nitrate, magnesium, potassium, calcium, urea, phosphate, sulphur or any nutrient that may be beneficial to add to soil to increase its fertility.

13. The method of claim 11, may comprise capturing all the gasses, oils and fertilizer nutrients from the reactor chamber from agricultural products after harvest to capture nutrients for recycling and reuse.
